(19) United States
(12) Patent Application Publication
(10) Pub. No.: US 2007/0154701 A1
(43) Pub. Date: Jul. 5, 2007

(54) Polyurethane films and method of fabricating the same

(75) Inventors: Te-Jong Kuai, Taipe County (TW); Ruei-Shin Chen, Changhua County (TW); Chia-Lin Wen, Miaoli County (TW); Yuung-Ching Sheen, Hsinchu County (TW); Yih-Her Chang, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/509,665

(22) Filed: Aug. 25, 2006

(30) Foreign Application Priority Data
Dec. 30, 2005 (TW) 94147649

(51) Int. Cl. B29C 65/00; B29C 44/04; B32B 3/26

(52) U.S. Cl. 428/304.4; 264/45.1; 264/41

(57) ABSTRACT

A polyurethane film. The polyurethane film includes a plurality of pores distributed from surface to interior. The invention also provides a method of fabricating the polyurethane film.

### BACKGROUND OF THE INVENTION

1. Field of the Invention

The invention relates to a thin film, and in particular to a polyurethane film and a fabrication method thereof.

2. Description of the Related Art

Wet phase inversion process has been widely used in porous polyurethane film, reverse osmosis film, and ultrafilter film fabrication. These films, however, provide an asymmetrical and close-cell porous structure, as shown in FIG. 1.

Related asymmetric film fabrication comprises adding a polymer solution into a coagulation bath with solvent and non-solvent to agglomerate a film, immersing the film in deionized water to remove residual solvent and non-solvent thereof, and drying the film in an vaccum oven at room temperature, as disclosed in U.S. Pat. No. 5,708,040, U.S. Pat. No. 5,628,942, CA 1,091,409, U.S. Pat. No. 4,450,126, and EP 597,300, wherein a combination of dry phase-inversion and wet phase inversion processes, that is, a polymer solution first pre-agglomerated with non-solvent steam or vapor then agglomerated completely in a coagulation bath with solvent and non-solvent. Finally, the film is an asymmetrical porous structure with surface layer.

Currently, the methods for fabricating open-cell coating films are usually processed at high temperature and non-continuous processes. Thus, organic materials such as polyurethane films requiring low-temperature process and continuous coating are not suitable therefor. In related literatures, isotactic polypropylene (i-PP) crystalline polymer has been used to fabricate an ultra hydrophobic film by phase inversion process. However, this is also a non-continuous process and high temperature is require.

### BRIEF SUMMARY OF THE INVENTION

The invention provides a polyurethane film comprising a plurality of pores distributed from surface to interior.

The invention also provides a method of fabricating a polyurethane film, involving coating a polyurethane solution on a substrate, immersing the substrate in a coagulation bath with at least one non-solvent to agglomerate a polyurethane film having pores distributed from surface to interior, and removing residual solvent and non-solvent from the polyurethane film by a non-polar solvent.

A detailed description is given in the following embodiments with reference to the accompanying drawings.

### BRIEF DESCRIPTION OF THE DRAWINGS

The invention can be more fully understood by reading the subsequent detailed description and examples with reference made to the accompanying drawings, wherein:

FIG. 1 is a SEM cross section of a related asymmetrically close-cell porous polyurethane film structure.

FIG. 2 is a SEM cross section of a symmetrical open-cell porous polyurethane film structure of the invention.

FIG. 3 shows contact angle of the polyurethane film of the invention.

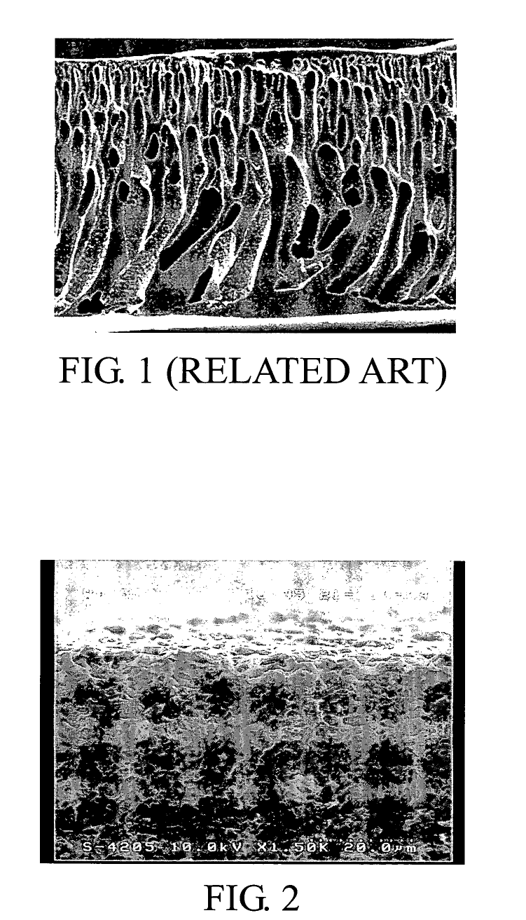

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a polyurethane film comprising a plurality of pores distributed from surface to interior with various diameters range 0.1 μm to 50 μm.

The polyurethane is a kind of solvent-based polyurethane such as CW835 polyester-type polyurethane (composed of methylene diphenyldiisocyanate (MDI), 1,2-ethanediol, caprolactone, adipic acid, and N,N-dimethylformamide (DMF)).

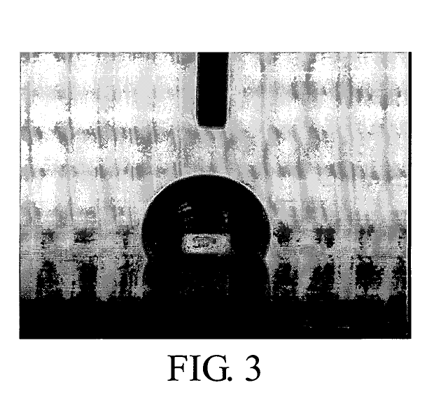

The disclosed polyurethane film provides a symmetrically open-cell porous structure, as shown in FIG. 2. The polyurethane film provides a less contact area and a contact angle to water over 120°, as shown in FIG. 3. Therefore, pollutants may be easily taken away by rainwater/dew from the surface.

The invention also provides a method of fabricating a polyurethane film, comprising the following steps. A polyurethane solution is coated on a substrate. The substrate is then immersed in a coagulation bath with at least one non-solvent to agglomerate a polyurethane film with pores distributed from surface to interior. Finally, residual solvent and non-solvent are removed by a non-polar solvent. The coagulation bath with at least one non-solvent further comprises a solvent. The solvent and non-solvent may have a ratio of about 1:99˜50:50. Moreover, 80˜99% non-solvent is preferable. The solvent may be N,N-dimethylformamide (DMF) or N,N-dimethylacetamide (DMAc). The non-solvent may be water or glycerol.

After agglomerating, a sol-gel type polyurethane film is formed. Residual solvent and non-solvent therein are then removed by a low-boiling-point and non-polar/low-polar solvent such as n-hexane, methanol, or isopropanol, preferably n-hexane.

The polyurethane film fabrication is a continuous process conducted at room temperature.

### EXAMPLE 1

A polyurethane solution was coated on a glass substrate by a coater. The coating thickness was about 250˜500 μm. The substrate was then immersed in a coagulation bath with N,N-dimethylformamide (DMF) and deionized water to agglomerate a sol-gel type polyurethane film. The DMF and water had a ratio of 1:99. After 4 hours, the polyurethane film was immersed in n-hexane to remove residual solvent and non-solvent therefrom. Finally, n-hexane was removed in vacuum-oven at room temperature. A symmetrically porous polyurethane film without skin layer was thus obtained.

### EXAMPLE 2

A polyurethane solution was coated on a glass substrate by a coater. The coating thickness was about 250˜500 μm. The substrate was then immersed in a coagulation bath with N,N-dimethylformamide (DMF) and deionized water to agglomerate a sol-gel type polyurethane film. The DMF and water had a ratio of 50:50. After 4 hours, the polyurethane film was immersed in n-hexane to remove residual solvent and non-solvent therefrom. Finally, n-hexane was removed in vacuum-oven at room temperature. A symmetrically porous polyurethane film was thus obtained.

### EXAMPLE 3

A polyurethane solution was coated on a glass substrate by a coater. The coating thickness was about 250˜500 μm. The substrate was then immersed in a solution coagulation bath with N,N-dimethylformamide (DMF) and deionized water to agglomerate a sol-gel type polyurethane film. The DMF and water had a ratio of 20:80. After 4 hours, the polyurethane film was immersed in n-hexane to remove residual solvent and non-solvent therefrom. Finally, n-hexane was removed in vacuum-oven at room temperature. A symmetrically porous polyurethane film was thus obtained.

### COMPARATIVE EXAMPLE 1

A polyurethane solution was coated on a glass substrate by a coater. The coating thickness was about 250˜500 μm. The substrate was then dried in an oven for several hours. A polyurethane film without any porous structure and having surface contact angle of 65.96 was obtained.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polyurethane film comprising a plurality of pores distributed from surface to interior.

2. The polyurethane film as claimed in claim 1, wherein the polyurethane is a kind of solvent-based polyurethane.

3. The polyurethane film as claimed in claim 1, wherein the pores have a diameter of about 0.1˜50 μm.

4. A method of fabricating a polyurethane film, comprising:
coating a polyurethane solution on a substrate;
immersing the substrate in a coagulation bath with at least one non-solvent to agglomerate a polyurethane film with pores distributed from surface to interior; and
removing residual solvent and non-solvent in the polyurethane film by a non-polar solvent.

5. The method of fabricating a polyurethane film as claimed in claim 4, wherein the polyurethane is a kind of solvent-based polyurethane.

6. The method of fabricating a polyurethane film as claimed in claim 4, wherein the coagulation bath with at least one non-solvent further comprises a solvent.

7. The method of fabricating a polyurethane film as claimed in claim 6, wherein the solvent and non-solvent have a ratio of about 1:99˜50:50.

8. The method of fabricating a polyurethane film as claimed in claim 4, wherein the non-solvent comprises water or glycerol.

9. The method of fabricating a polyurethane film as claimed in claim 6, wherein the solvent comprises N,N-dimethylformamide (DMF) or N,N-dimethylacetamide (DMAc).

10. The method of fabricating a polyurethane film as claimed in claim 4, wherein the non-polar solvent comprises n-hexane, methanol, or isopropanol.

11. The method of fabricating a polyurethane film as claimed in claim 4, wherein the fabrication is conducted at room temperature.

12. The method of fabricating a polyurethane film as claimed in claim 4, wherein the fabrication is a continuous process.

13. The method of fabricating a polyurethane film as claimed in claim 4, wherein the pores of the polyurethane film have a diameter of about 0.1˜50 μm.
